(19) United States
(12) Patent Application Publication
(10) Pub. No.: US 2026/0284683 A1
(43) Pub. Date: Sep. 24, 2026

(54) DISPENSING DEVICE FOR MULTIPHASE LIQUIDS

(71) Applicant: SOEFIA S.r.l., Bovisio-Masciago (MB) (IT)

(72) Inventors: Barbara APPERTI, MONZA (MB) (IT); Paolo MAPELLI, MONZA (MB) (IT)

(21) Appl. No.: 19/574,234

(22) Filed: Mar. 20, 2026

(30) Foreign Application Priority Data
Mar. 21, 2025 (IT) 102025000005847

(51) Int. Cl. B05B 11/10; B05B 11/00

(52) U.S. Cl. CPC B05B 11/1081; B05B 11/0091

(57) ABSTRACT

A dispensing device (1) is provided for multiphase liquids comprising a closed casing (2) defining at least one chamber (20) configured to contain one or more substances and one bottom (21) suitable for facing a ground when said device (1) is in use; a multiphase liquid (3) housed within said chamber (20) and including at least a first component (30) and a second component (31) of lower and immiscible density with respect to the first component (30) so as to form, at least when the multiphase liquid (3) is at rest, an interface surface (32) that delimits the components (30,31); a dispenser (4) including an ejection mechanism (40) connected to the casing (2) opposite the bottom (21) configured to pump, in response to a manual pumping command, the multiphase liquid (3) from the chamber (20) outwards, a first cannula (41) comprising at least a first inlet (41b) at its own first free end (41a) and developing such that said first inlet (41b) is immersed in said first component (30), a second cannula (42) comprising at least a second inlet (42b) and a float (5) arranged at said second end (42a) and configured such that said second inlet (42b) is immersed in said second component (31); wherein the float (5) defines a total density lower than the first component (30) and higher than the second component (31) such that the second end (42a) can be kept close to the interface surface (32).

The present invention relates to a dispensing device for multi-phase liquids of the type specified in the preamble to the first claim.

Specifically, the present invention relates to a dispensing device for liquids comprising a plurality of phases, preferably two phases, provided with a holding tank and a dispenser.

As is well known, liquid substances used inside bottles, such as for hygienic or cosmetic purposes, or even food containers, can be of the multiphase type. Multiphase liquids are basically made up of a heterogeneous mixture of two or more components that form at least two phases. When there are two phases, in particular, it is called a biphasic substance.

The phases involved in the multiphase substance may exhibit either the same or different aggregation state. Unlike homogeneous mixtures, in biphasic substances there is always the presence of a separation interface between the at least two phases. In the case of liquid multiphase substances, in particular, the phasic components consist of liquids that are immiscible with each other.

Among the devices for dispensing multiphase substances in the liquid state, for example, the Sheridan™ brand dual tank bottle is well known.

Such a bottle basically comprises two immiscible liquids arranged, each, within its own tank, or chamber. In addition, the container includes a dispenser configured to mix the two liquids when dispensed.

Of course, the liquids in question are food grade.

However, as mentioned above, there are also other types of multiphase, preferably biphasic, liquids in cosmetics.

In order to enable simultaneous dispensing and mixing of phases, devices have been made as described, for example, in the patent applications GB-A-1180427, U.S. Pat. No. 3,760,986, WO-A-0126821 and WO-A-2010133209.

The cosmetic dispensing devices described in the above questions also include a tank dedicated to each phasic component and a dispenser configured to mix the components when operated.

Therefore, in order to contain and dispense multiphase liquids, devices in the known technique teach to use separate tanks for each component and to mix the components only during dispensing.

Alternatively, there are two-phase cosmetics that include the phasic components within the same bottle.

However, before using the liquid, it is generally necessary to manually stir the contents of the bottle to bring the different phases included therein to mix.

Thus, the prior art described comprises some important drawbacks.

Specifically, according to known information, in order to use a multiphase liquid, it is necessary to make a multi-chamber container in which the chambers are individually connected to a common dispenser. Therefore, the container turns out to be rather complex and, likely, not very economical.

The alternative configuration described, on the other hand, has the important drawback of forcing the user to manually stir the bottle, such as by repeatedly shaking it.

To try to overcome the stated drawbacks, a dispenser was developed as described in patent application EP-A-4161706.

The patent application describes a dispensing device for multiphase liquids comprising a closed casing defining at least one chamber configured to contain one or more substances, a multiphase liquid including at least a first component housed within the chamber, and a second component housed within the chamber, of a different density and immiscible with respect to the first component so as to form, at least when the multiphase liquid is at rest, an interface surface bounding the phasic components, a dispenser including a cannula defining a first direction of extension in such a manner as to access the multiphase liquid, and an ejection mechanism arranged on top of the casing, operatively connected to the cannula and configured to pump the multiphase liquid from the chamber outward, wherein the cannula includes a plurality of first accesses arranged in planes spaced along the first direction of extension in such a manner that at least two of the first accesses are separated from the interface surface and the ejection mechanism pumps the first component and the second component simultaneously.

Also, the prior art just described comprises some important drawbacks.

Specifically, the number of phasic components dispensed depends on the number of holes or the diameter of the cannula section interacting with the component, but during dispensing at the pump, there is no control over the amount of the two phasic components to be dispensed.

Therefore, unless the cannula is specifically sized, which is relatively inconvenient in technical and economic terms anyway, it is not possible to deliver multiphase liquids with different number of phases.

Moreover, with a view to keeping the dispenser of the per se well-known and very common type, it is not even possible to assume ad hoc modification of the dispenser in order to determine different dispensing amounts.

This is further compounded by the fact that if the phase placed above is reduced, the section of cannula that draws from it could mistakenly interfere with the phasic fluid placed below it as well, defeating the technical effects intended to be achieved by a multiphasic device.

In fact, an additional major drawback of the device described in patent application EP-A-4161706 is that during multiphase liquid consumption, the behavior of the nozzle changes due to the fact that the mode of interaction between cannula and phasic liquids changes.

In this situation, the technical task underlying this invention is to devise a multiphase liquid dispensing device capable of substantially overcoming at least part of the aforementioned drawbacks.

Within the said technical task, it is an important purpose of the invention to obtain a dispensing device for multiphase liquids that is simpler and less structurally complex than devices of the prior art.

Another important purpose of the invention is to make a dispensing device for multiphase liquids that enables the mixing of phasic components to be accomplished without resorting to manual mixing by a user.

In addition, a further task of the invention is to realize a dispensing device for multiphase liquids that enables effective and efficient mixing of phasic components against the previously stated purposes.

In particular, an additional purpose of the invention is to prevent multiphase fluids from being delivered in incorrect proportions, for example, due to improper interaction of cannula sections with different fluids.

In conclusion, a further task of the invention is to realize a dispensing device for multiphase liquids that enables it to maintain high efficiency without the need to modify conventional components, such as the pump dispensing mechanisms preferably employed, and that is capable of ensuring the same dispensing mode at all times during the consumption of multiphase liquid contained therein.

The technical task and the specified aims are achieved by a dispensing device for multiphase liquids as claimed in the annexed claim 1.

Preferred technical solutions are highlighted in dependent claims.

The characteristics and benefits of the invention will be clarified in the following detailed description of some preferred embodiments of the invention, with reference to the accompanying drawings, wherein:

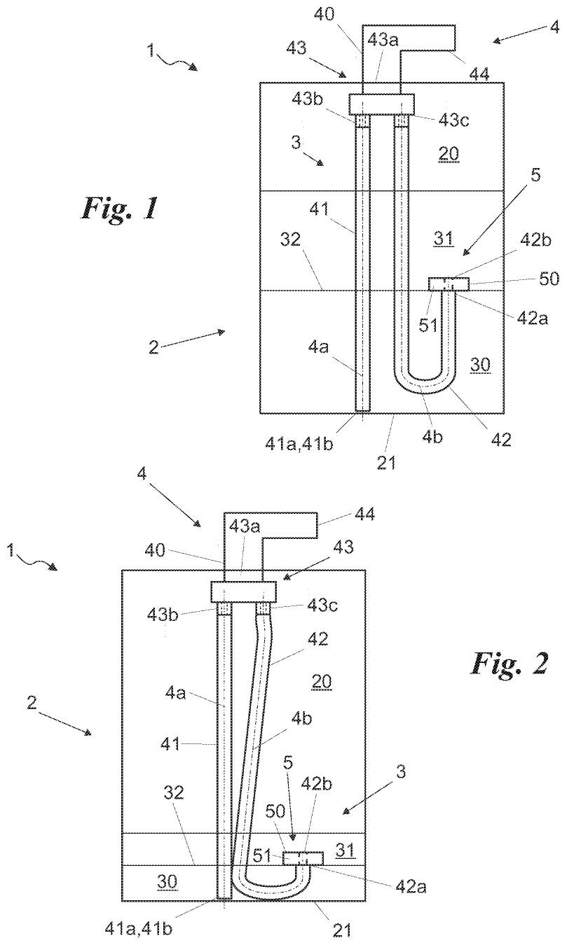

FIG. 1 shows a simplified scheme of a multiphase liquid dispensing device according to the invention in a first embodiment in which the second cannula is deformable;

FIG. 2 illustrates a simplified scheme of the dispensing device for multiphase liquids in FIG. 1 in which the float dropped in concordance with the decreasing liquid level in the chamber, the second cannula became deformed, and the second inlet is always immersed in the second component;

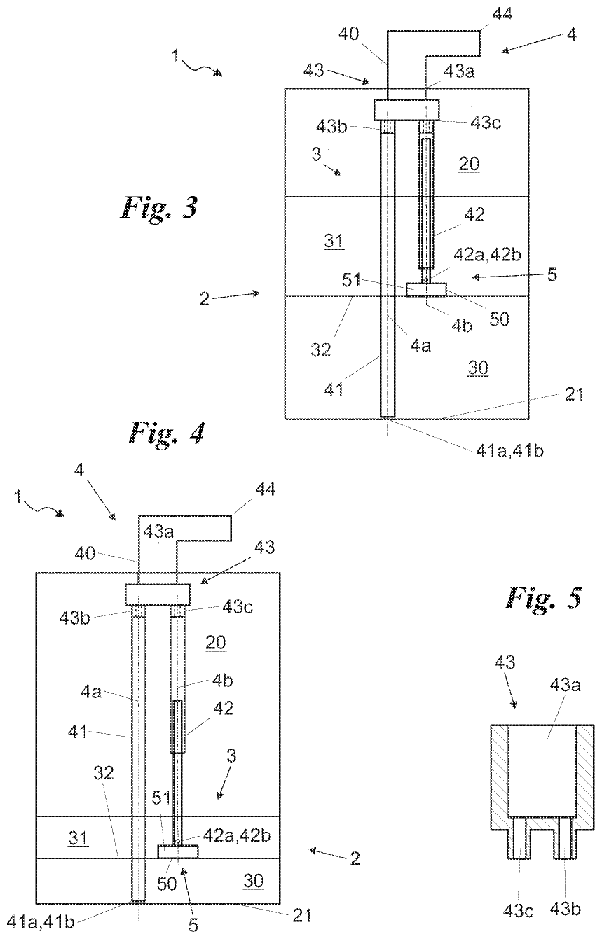

FIG. 3 shows a simplified scheme of a dispensing device for multiphase liquids according to the invention in a further embodiment in which the second cannula is rigid and telescopic by including a piston equipped with a float;

FIG. 4 illustrates a simplified scheme of the dispensing device for multiphase liquids in FIG. 4 in which the float dropped in concordance with the decrease of the liquid level in the chamber, and the piston of the telescopic cannula followed, thanks to the float, the first component;

FIG. 5 illustrates a portion of the dispensing device for multiphase liquids according to the invention.

In this document, when measurements, values, shapes, and geometric references (such as perpendicularity and parallelism) are associated with words like “approximately” or other similar terms, such as “almost” or “substantially”, they are to be understood as excluding measurement errors or inaccuracies due to production and/or manufacturing errors and, above all, as having less than a slight deviation from the associated value, measurement, shape, or geometric reference. For example, if associated with a value, such terms preferably indicate a departure of no more than 10% of the value itself.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as reflected in the following discussions, terms such as “processing”, “computing”, “determination”, “computation”, or the like are considered to refer to the action and/or processes of a computer or similar electronic computing device that manipulates and/or transforms data represented as physical, such as electronic quantities of records of a computer system and/or memories, in other data similarly represented as physical quantities within computer systems, records, or other information storage, transmission, or display devices.

The measurements and data reported in this text are to be considered, unless otherwise indicated, as performed in the International Standard Atmosphere ICAO (ISO 2533:1975).

With reference to the figures, the dispensing device for multiphase liquids according to the invention is globally indicated with the number 1.

Device 1 is preferably configured to accommodate at least one multiphase liquid 3.

In this regard, device 1 includes at least one casing 2.

Casing 2 is basically a container, of any shape, configured to allow at least one liquid to be housed within it. Also, preferably, casing 2 is closed, i.e., not accessible from the outside.

Specifically, casing 2 defines at least one chamber 20.

Chamber 20 is basically a space or housing within which multiphase liquid 3, preferably in a liquid state, can be placed. Of course, casing 2 could include a plurality of chambers 20, for example, each including its own multiphase liquid 3 different from the others. However, in a preferred embodiment, casing 2 comprises only one chamber 20.

In addition, preferably, casing 2 also defines a bottom 21. As such, the bottom 21 is preferably suitable to face a ground when device 1 is in use. It is the lower portion of the casing, that is, the portion that prevents, when device 1 is in use, the gravity fall of what is contained in casing 2.

Multiphase liquid 3 is therefore preferably housed in chamber 20.

Multiphase liquid 3 can be food grade, or other type. Preferably, multiphase liquid 3 is a cosmetic. In even more detail, the multiphase liquid 3 may be a bubble bath.

As such, the multiphase liquid 3 preferably comprises at least a first component 30 and a second component 31. In this case, essentially, the multiphase liquid 3 is a biphasic liquid.

Of course, the multiphase liquid 3 could include other additional phasic components. In any case, the first component 30 and the second component 31 are preferably both housed in the chamber 20. They are preferably any substances, preferably in the liquid state, of different density.

Preferably, the second component 31 has lower density than the first component 30. Therefore, when multiphase liquid 3 is at rest and device 1 is in use, such as resting on a plane or floor, the first component 30 is arranged adjacent to the bottom 21 and keeps the second component 31 separate from the bottom 21.

Furthermore, the first component 30 and the second component 31 are mutually immiscible. Therefore, the phasic components 30, 31 form, at least when the multiphase liquid 3 is at rest or decanted, an interface surface 32.

The interface surface 32 substantially delimits, inside the chamber 20, the first component 30 and the second component 31.

The interface surface 32 is, therefore, an abstract barrier determined by the separation, due to the immiscibility and the different density, of the phasic components 30, 31.

The device 1 therefore comprises a dispenser 4.

The dispenser 4 can be substantially mostly similar to the common dispensers that can be found on the market. An example of a dispenser suitable for the device 1 can be any conventional dispenser present in intimate detergents.

The dispenser 4 is preferably a pump dispenser, per se known to those skilled in the art. The term pump dispenser means that the dispenser itself comprises a pump, preferably manually activated and preferably arranged in correspondence with the dispenser 4. Said pump is activated by pressing the dispenser 4 and creates a depression in a chamber which activates the suction of fluid from inside the chamber. The dispenser 4 is preferably a pump dispenser configured to deliver liquid product and is for example quite similar to liquid soap dispensers, in particular it comprises a nozzle with a diameter greater than one millimeter. Alternatively, the dispenser 4 is a pump dispenser capable of emitting nebulized product and preferably comprises a nebulizer nozzle.

Again alternatively, the dispenser 4 is not a pump dispenser but a spray or aerosol dispenser and the casing 2 is made of pressure. In this case, the nozzle is preferably a nebulizer nozzle or, alternatively, a nozzle for dispensing liquid.

Thus, in general, dispenser 4 includes at least one ejection mechanism 40.

The mechanism 40 is preferably placed opposite bottom 21. Therefore, when device 1 is in use, mechanism 40 lays on the top of casing 2. In particular, mechanism 40 is arranged on the top of casing 2 relative to the ground at least when device 1 is in use.

With the term “in use”, as already said, it is intended a conventional situation in which device 1 is oriented correctly, with casing 2 resting on a surface and dispenser 4 accessible from above, with respect to the ground. This configuration is useful for describing the orientation of the various elements of the device 1, however it is not necessarily the only condition of use and therefore does not limit the device 1 to the only condition of use considered for the description.

Mechanism 40, therefore, is in fluid passage connection with chamber 20. In addition, it is configured to pump the multiphase liquid 3 from the chamber 20 to the outside. More in detail, preferably, mechanism 40 is configured to pump the multiphase liquid 3 from chamber 20 to the outside in response to a manual pumping command.

A mechanism of this type may include and/or be determined by a common push button as present in most of the known dispensers for intimate cleanser. Therefore, the pumping command can correspond to a typical situation where the dispenser is pressed, for example with a finger of a user's hand to dispense the multiphase liquid 3.

In addition, the dispenser 4 includes also at least a first cannula 41 and a second cannula 42.

The cannulas 41, 42 are substantially the portion of dispenser 4 configured to be immersed in whole or in part in the multiphase liquid 3. They are tubular elements through which the multiphase liquid 3 can flow from chamber 20 to mechanism 40 to be dispensed by device 1.

The first cannula 41 is operatively connected to mechanism 40.

Furthermore, it defines a first extension direction 4a.

The first extension direction 4a is the direction along which the first cannula 41 develops. In particular, the first extension direction 4a is transverse with respect to bottom 21.

Furthermore, the first cannula 41, includes at least a free first end 41a.

The first end 41a is essentially the part of the first cannula 41 opposite mechanism 40. Therefore, the first cannula 41 extends from mechanism 40 to the first end 41a.

Furthermore, the first cannula 41 also includes a first inlet 41b.

The first inlet 41b is placed at the first end 41a. It can correspond to an opening at the end of the first cannula 41 or also a through-hole in the side walls of the first cannula 41.

In any case, preferably, the first cannula 41 develops along the first extension direction 4a, transverse to bottom 21, so that the first end 41a is near to the bottom 21.

Therefore, given its position, the first inlet 41b is itself advantageously immersed in the first component 30.

The second cannula 42 is also operatively connected to mechanism 40.

Furthermore, it defines a second extension direction 4b.

The second extension direction 4b is the direction along which the second cannula 42 develops.

Furthermore, the second cannula 42 includes, like the first cannula 41, at least a free second end 42a.

The second end 42a is essentially the part of the second cannula 42 opposite mechanism 40. Therefore, the second cannula 42 extends from mechanism 40 to the second end 42a.

Furthermore, the second cannula 42 also includes a second inlet 42b.

The second inlet 42b is placed at the second end 42a. It can correspond to an opening at the end of the second cannula 42 or also a through-hole in the side walls of the second cannula 42.

Advantageously, the second cannula 42 also includes a float 5.

The float 5 is placed, as the second inlet 42b, at the second end 42a.

In addition, the second inlet 42b and float 5 are configured so that the second inlet 42b is immersed in the second component 31.

Therefore, each inlet 41b, 42b communicates with a respective component 30, 31.

In this regard, advantageously, the float 5 preferably defines a total density lower than the first component 30 and higher than the second component 31. This allows to keep the second end 42a next to the interface surface 32, naturally immersed in the second component 31.

This embodiment is particularly advantageous, but there could also be embodiments wherein the float 5 is suitable for floating also on the second component 31.

In general, preferably, the float 5 includes a sac 50.

The sac 50 is preferably hermetically closed. For example, it can be a membrane element, with thin thickness. In addition, the sac 50 defines a first partial density higher than the components 30, 31.

Therefore, float 5 can include also a third component 51.

If present, the third component 51 is also liquid. Furthermore, it is preferably the predominant component by volume and is contained within sac 50. Therefore, the third component 5 defines preferably a second partial density lower than at least the first component 30, and may be higher, though not necessarily, than the second component 31.

To ensure the connection between the mechanism 40 and the cannulas 41, 42, the dispenser 4 includes also a connector 43. A preferred version of the same connector 43 is illustrated in FIG. 5.

The connector 43 connects, preferably in a detachable way, mechanism 40 and cannulas 41, 42.

Therefore, connector 43 includes at least a duct 43a and a branching.

Duct 43a is connected to mechanism 40. Therefore, it may consist of a sleeve that can be slipped over a portion of the dispenser 4, particularly—but not exclusively—when the mechanism 40 is integrated into a collar at the coupling point between the dispenser 4 and the casing 2.

The branching, on the other hand, is formed by at least a first channel 43b and a second channel 43c. If the branching includes only channels 43b, 43c it corresponds essentially to a bifurcation.

Therefore, the first channel 43b is connected to the first cannula 41, while the second channel 43c is connected to the second cannula 42. Channels 43b, 43c can correspond to tubular collars onto which a respective cannula 41 or 42 can be slipped.

Connector 43 includes further characteristics.

In particular, advantageously, each of the channels 43b, 43c defines a respective constriction in the respective cannula 41,42. This means that, at the same flow rate—which is determined by the internal extension of each cannula 41, 42—each corresponding channel 43b, 43c causes a reduction in flow rate due to the local reduction in cross-sectional area caused by the constriction.

Therefore, due to this reduction in size, it is possible to control the amount of the respective component 30, 31 dispensed through the respective cannula 41, 42.

Constrictions can be equivalent in size. Otherwise, constrictions can be mutually different so that from the same pumping command imparted through said mechanism 40, different amounts of said components 30, 31 can be dispensed.

Therefore, in order to dispense different quantities of components 30, 31 it is not necessary to use cannulas 41, 42 of different sizes. In fact, in at least one preferred embodiment, the cannulas 41, 42 may define an equivalent dispensing cross-section transverse to their respective dispensing directions 4a, 4b, i.e., they may be dimensionally equivalent.

The dispenser 4 may further include, a spout 44.

The spout 44 is operatively connected to mechanism 40 and in fluid passage connection with the cannulas 41, 42.

In particular, preferably, the spout 44 is configured to mix the first component 30 and the second component 31 during the expulsion of the multiphase liquid 3 from the casing 2.

Dispenser 4, advantageously, can also include further characteristics.

For example, in a preferred embodiment as shown in FIGS. 1-2, the first cannula 41 is stiff. Therefore, in this case, the first cannula 41 retains the same shape regardless of the multiphase liquid 3.

Alternatively, preferably, the second cannula 42 is deformable. Therefore, driven by float 5, it changes shape in response to the level of multiphase fluid 3 inside casing 2.

In an alternative embodiment as shown in FIGS. 3-4, the second cannula 42 can also be stiff.

However, in this case it is preferably extendable. Therefore, the second cannula 42 preferably includes a piston to which end the float 5 is connected, and the second inlet 42b is configured to remain in communication with the second component 31 at all times.

In this regard, as shown, the piston may have a predetermined stroke along the second extension direction 4b such that, as the level of the first component 30 changes, the second inlet 42b remains immersed in the second component 31.

The operation of the multiphase liquid dispensing device 1 previously described in structural terms is as follows.

Essentially, when a user presses mechanism 40, cannulas 41, 42 allow both phase components 30, 31 to be pumped from chamber 20 through the constriction formed by channels 43b, 43c on connector 43.

The two components 30, 31 are then mixed at the outlet also thanks to the presence of a possible spout 44.

The design of the connector 43 and float 5 also makes it possible to create new dispensing kits.

A first dispensing kit can include device 1 as described above and a plurality of connectors 43. Therefore, connectors 43 of the kit advantageously define different branching combinations.

Thus, in relation to one another, the connectors 43 may define respective first channels 43a that define a mutually different constriction and/or respective second channels 43c that define a mutually different constriction.

In particular, if the float 5 is removable from the second end 42a, or if the second cannula 42 can be replaced entirely with its own float 5, the invention makes it possible to obtain a second dispensing kit.

The second dispensing kit can include device 1 as described above and a plurality of floats 5. Of course, in this case, the floats 5 preferably have different overall densities so that they can be adapted to different combinations of components 30, 31.

Of course, the invention may also include a third kit that incorporates features from both the first kit and the second kit.

In any case, the dispensing device for multiphase liquids 1 according to the invention achieves important advantages.

In fact, the device 1 is simpler and less complex structurally than the devices of the known art. It includes a casing with a single chamber 20 and a dispenser, made ad hoc, which allows to obtain great efficiency without additional costs compared to common bottles.

Furthermore, a further advantage is given by the fact that the multiphase liquid dispensing device allows to carry out the mixing of the phase components, moreover with great efficiency, without resorting to manual mixing by a user.

In particular, thanks to the constrictions, device 1 allows to balance the quantity of components to be mixed.

Furthermore, the design of the float ensures that there is always the right pumping of both components 30,31 avoiding situations wherein one of the two is missing. In conclusion, a further advantage is given by the fact that the liquid dispensed by the device 1 is excellent and is mixed with great efficiency since it allows to avoid unwanted foaming deriving from any pumping of air, simultaneously with the multiphase liquid 3, to the spout 44 or in any case to the outlet of the dispenser 4 since inlets 41b and 42b are always immersed in their respective components 30, 31.

The invention can be modified to create different versions falling within the scope of the inventive concept defined by the claims.

For example, to limit the effects caused by airflow, there may be more than two inlets 41b, 42b on the respective cannulas 41, 42. In addition, or as an alternative, additional components of the multiphase liquid 3 may also be included, and for example additional cannulas with corresponding channels on the connector and a float to be positioned between two phases. In this case, the various floats should have densities that keep them at different levels, each between two different components.

In this context, all the details can be replaced by equivalent elements and any materials, shapes and dimensions can be used.

For example, connector 43 may not be present and the correct size of the opening of the hole can be placed at the level of the float 5, for example by means of a replaceable regulator or otherwise.

1. Dispensing device (1) for multiphase liquids comprising:
a closed casing (2) defining at least one chamber (20) configured to contain one or more substances and a bottom (21) suitable for facing a ground when said device (1) is in use;
a multiphase liquid (3) housed within said chamber (20) and including at least:
a first component (30),
a second component (31) of a lower density and not mixable with said first component (30) so as to form, at least when said multiphase liquid (3) is at rest, an interface surface (32) bounding said components (30,31);
a dispenser (4) including:
an ejection mechanism (40) connected to said casing (2) on the opposite side to said bottom (21) in fluid passage communication with said chamber (20) and configured to pump, in response to a manual pumping command, said multiphase liquid (3) from said chamber (20) outwards,
a first cannula (41) operatively connected to said mechanism (40), comprising at least a first inlet (41b) at its own first free end (41a) and developing along a first direction of extension (4a) transverse to said bottom (21) such that said first end (41a) is close to said bottom (21) and said first inlet (41b) is immersed in said first component (30),
a second cannula (42) operatively connected to said mechanism (40), developing along a second extension direction (4b) from said mechanism (40) to its own free second end (42a) and comprising at least a second inlet (42b) and a float (5) arranged at said second end (42a) and configured such that said second inlet (42b) is immersed in said second component (31);
and characterized by the fact that
said float (5) defines a total density lower than said first component (30) and higher than said second component (31) such that said second end (42a) can be kept close to said interface surface (32).

2. Device (1) according to claim 1, wherein said float (5) comprises a hermetically sealed sac (50) defining a first partial density greater than said components (30, 31) and a third volumetrically prevailing liquid component (51) contained in said sac (50) and defining a second partial density lower than at least said first component (30).

3. Device (1) according to claim 1, wherein said first cannula (41) is rigid and maintains the same shape independently of said multiphase liquid (3).

4. Device (1) according to claim 1, wherein said second cannula (42) is deformable and changes, pulled by said float (5), its shape depending on the level of said multiphase liquid (3) within said casing (2).

5. Device (1) according to claim 1, wherein said dispenser (4) further includes a connector (43) connecting in a detachable way said mechanism (40) and said cannulas (41, 42) and including a duct (43a) connected to said mechanism (40) and a branch formed by a first channel (43b) connected to said first cannula (41) and a second channel (43c) connected to said second cannula (42); each of said channels (43b, 43c) defining a respective constriction with respect to said respective cannula (41, 42) so as to manipulate the amount of said respective component (30, 31) delivered through said respective cannula (41, 42).

6. Device (1) according to claim 5, wherein said constrictions are mutually different so that from the same said pumping command imparted through said mechanism (40), different amounts of said components can be dispensed (30, 31).

7. Device (1) according to claim 1, wherein said cannulas (41, 42) define an equivalent dispensing section transverse to said respective extension direction (4a, 4b).

8. Device (1) according to claim 1, wherein said dispenser (4) comprises a nozzle (44) operatively connected to said mechanism (40), in fluid passage connection with said cannulas (41, 42) and configured to mix said first component (30) and said second component (31) during the expulsion of said multiphase liquid (3) from said casing (2).

9. Device (1) according to claim 1, wherein said dispenser (4) is a pump dispenser.

10. Dispensing kit comprising a device (1) according to claim 1, and a plurality of said floats (5) defining mutually different total densities such that they can be adapted to different combinations of said components (30, 31).
